(19) United States
(12) Patent Application Publication
(10) Pub. No.: US 2004/0145267 A1
(43) Pub. Date: Jul. 29, 2004

(54) Liners for stators and rotors of electric machines and methods of making

(76) Inventors: Michael Jeffrey Lowry, Indianapolis, IN (US); Frederick B. Reiter JR., Cicero, IN (US); Lisa K. Haller, Anderson, IN (US)

Correspondence Address: MARGARET A. DOBROWITSKY DELPHI TECHNOLOGIES, INC., Legal Staff, P.O. Box 5052, Mail Code: 480-410-202, Troy, MI, 48007-5052, US

(21) Appl. No.: 10/354,614

(22) Filed: Jan. 29, 2003

(51) Int. Cl. H02K 3/34; H02K 1/12

(52) U.S. Cl. 310/215; 310/254

(57) ABSTRACT

A liner for a stator of an electric machine is provided. The liner includes an insulating layer and a magnetically conducting layer. The insulating layer comprises a plurality of insulating strips, while the conducting layer comprises a plurality of conducting strips. The insulating and conducting layers are connected to each other in an alternating overlapping fashion to form a ribbon-like element. The ribbon-like element is connectable to the stator such that the insulating strips are positionable in winding slots of the stator and such that the conducting strips are mateable with the stator to cause a portion of the conducting strips to be across the openings in the stator.

This application is related to commonly owned and assigned U.S. patent application, Ser. No.______, attorney docket number DP-305899 filed contemporaneously with this application and the contents of which are incorporated by reference herein.

### TECHNICAL FIELD

This disclosure relates to liners for electric machines. More specifically, this disclosure relates to liners for the stator or rotor of an electric machine and methods of making such liners.

### BACKGROUND

Electric machines (e.g., motors or generators) have a stator secured within a housing. A rotor mounted on a shaft is positioned within the stator and is rotatable relative to the stator about the longitudinal axis of the shaft. The stator or rotor is typically constructed of copper wire coils inserted into insulated slots.

The individually insulated slots have tooth tips to partially cover the opening of the insulated slots. The tooth tips reduce the eddy current losses that would otherwise result due to airgap reluctance/flux variations. Various winding methods are used to insert the copper coils into the slots. Due to the limitations of the winding methods in inserting the copper coils into the narrow slot openings, the percentage of copper windings in the slots of the stator is between 50 and 60 percent.

### SUMMARY

A liner for a stator of an electric machine is provided. The liner includes an insulating layer and an electrically and magnetically conducting layer. The insulating layer includes insulating strips or bands, while the conducting layer includes electrically and magnetically conducting strips. The insulating and conductive layers are connected to form a ribbon-like element. The ribbon-like element has a length alternating between the conductive strips and the insulating strips in an overlapped manner. The ribbon-like element is connectable to the stator such that the insulating strips are positionable in winding slots of the stator and such that the conductive strips are mateable with the stator to form tooth tips.

A stator for an electric machine is provided having a stack of surface insulated ferromagnetic laminations. The stack includes winding slots disposed circumferentially about the stack. Here, each of the winding slots has an unrestricted opening. In an alternative embodiment, windings are disposed in each of the winding slots, and a liner is connected to the stack about the unrestricted openings to form tooth tips.

An electric machine having a stator core, stator windings, a stator core liner, and a rotor is provided. The stator core is a stack of surface insulated ferromagnetic laminations having an inner bore. The inner bore has stator winding slots disposed circumferentially therearound. Here, each of the stator winding slots has an unrestricted opening. The stator windings are disposed in the stator winding slots. The stator core liner is connected to the inner bore about the unrestricted openings to form tooth tips at the unrestricted openings. The rotor is rotatably disposed in the inner bore.

The above-described and other features and advantages of the present disclosure are appreciated and understood by those skilled in the art from the following detailed description, drawings, and appended claims.

### BRIEF DESCRIPTION OF THE DRAWINGS

FIG. 1 is a perspective view of an electric machine;

FIG. 2 is an exploded view of the electric machine of FIG. 1;

FIG. 3 is a front view of a stator core;

FIG. 4 is a sectional view of the stator of FIG. 3 taken along lines 4-4;

FIG. 5 is a front view of an exemplary embodiment of a stator core liner and a stator;

FIG. 6 is a sectional view of the stator of FIG. 5 taken along lines 6-6;

FIG. 7 is a schematic diagram of an exemplary embodiment of a manufacturing process for a stator core liner; and

FIGS. 8-17 are alternative exemplary embodiments of a stator core liner.

### DESCRIPTION OF THE PREFERRED EMBODIMENT

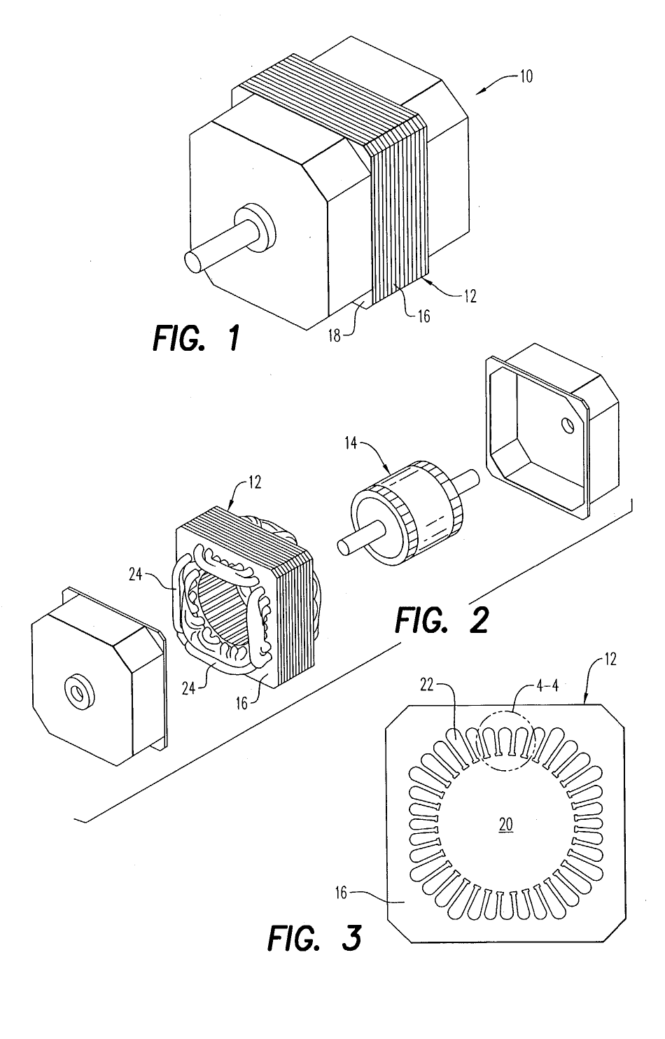

Referring now to FIGS. 1-3, an electric machine 10 is provided by way of example. Electric machine 10 includes a stator core 12 and a rotor 14. Here, stator core 12 is formed of a stack of laminations 16. Laminations 16 are formed of electrical steel, namely steel having a silicon content of about 0.0%-6% by weight. Of course, steel having a silicon content greater or less than the aforementioned range is contemplated in accordance with the present disclosure. Each lamination 16 is coated with an electrically non-conductive insulating coating 18. Thus, stator core 12 includes laminations 16 with coating 18.

It should be recognized that stator 12 is described above by way of example only as including a stack of layers. Of course, and as other applications require, use of continuously wound stator cores, segmented stator cores, solid metal cores, powdered metal cores, laminated metal cores, and the like are considered within the scope of the present disclosure.

Moreover, it should be recognized that stator 12 is described above by way of example only as being formed of electrical steel. Of course, and as other applications require, use of stator 12 being formed of any magnetically conductive, permeable, or ferromagnetic material such as but not limited to electrical steel, structural steel, stainless steel (e.g., 400 series), iron, nickel, cobalt, and alloys thereof.

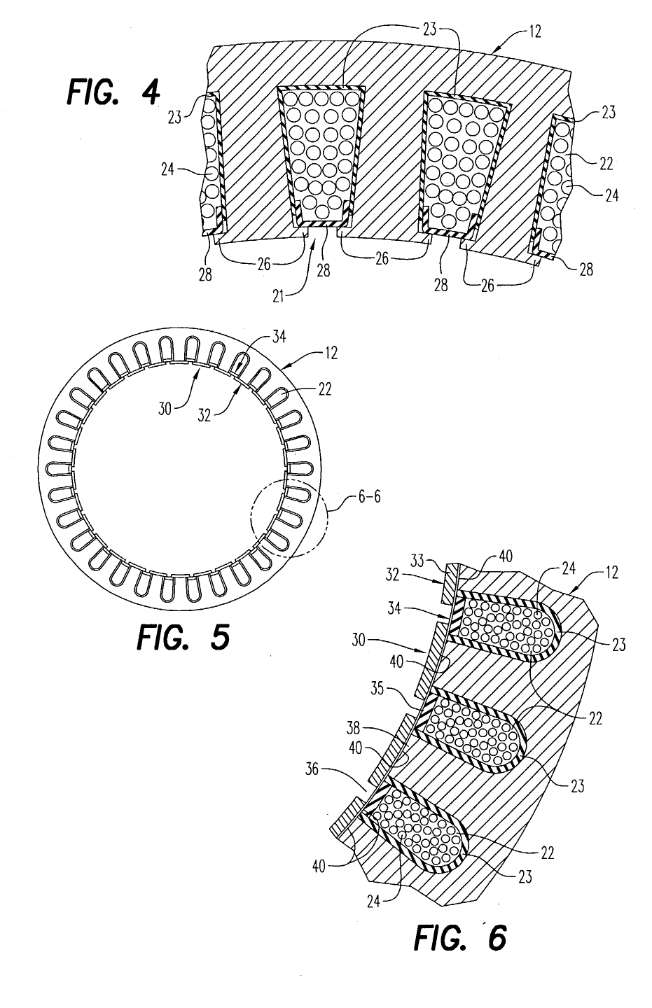

An example lamination 16 of stator core 12 is illustrated in FIGS. 3 and 4 with FIG. 4 being representative of an exemplary embodiment of the present disclosure. Of course, other stator configurations are contemplated to be used with the present disclosure. Here, lamination 16 includes a central bore 20 for receiving rotor 14 and a plurality of spaced apart slots 22 for receiving stator windings 24. Laminations 16 are stacked such that slots 22 are axially aligned with one another to form the individual poles of stator core 12 once the windings are inserted therein. After stacking laminations 16, slots 22 are provided with a layer of electrically non-conductive insulation 23 between slots 22 and stator windings 24. Insulation 23 is, for example, an insulating paper (e.g., NOMEX), MYLAR (e.g., KAPTON), polymers, and coatings thereof.

Slots 22 include tooth tips 26 disposed at the opening of the slots. Thus, as a result of tooth tips 26, slots 22 have a restricted opening or gap 21. Due to restricted opening 21, stator windings 24 are commonly axially inserted into slots 22. However, stator windings 24 are also often inserted into slots 22 through restricted opening 21. Regardless of the method used, restricted opening 21 results in a less than complete filling of slots 22 with winding 24, namely about 50% to 60% of each slot is filled with the windings. This low utilization of the amount of windings 24 in slots 22 causes motor 10 to exhibit less than maximum performance.

Tooth tips 26 minimize or reduce the eddy current losses that would otherwise result on the surface of rotor 14 due to air gap reluctance/flux variations. For example, tooth tips 26 leaving too large a slot opening 21 leads to a large magnetic field variation in the airgap between the stator tooth and slot opening 21. The magnetic field variation generates eddy current losses on the surface of the rotor 14, or additional load on motor 10. Alternately, tooth tips 26 having no opening 21 results in a closed slot stator core 12 resulting in leakage flux, or flux transfer between alternating poles, again reducing the efficiency of motor 10.

Thus, elimination of tooth tips 26 is not desirable from a motor performance standpoint. However, and in such a design, manufacturing difficulties arise during the insertion of windings 24 into slots 22 past tooth tips 26. Moreover, after insertion of stator windings 24, a non-conductive retaining clip or a slot wedge 28 must be inserted to secure the windings in slots 22 and insulate the windings from tooth tips 26. Further manufacturing difficulty and expense in the manufacture of stator core 12 is created by the insertion of slot wedge 28 into slots 22.

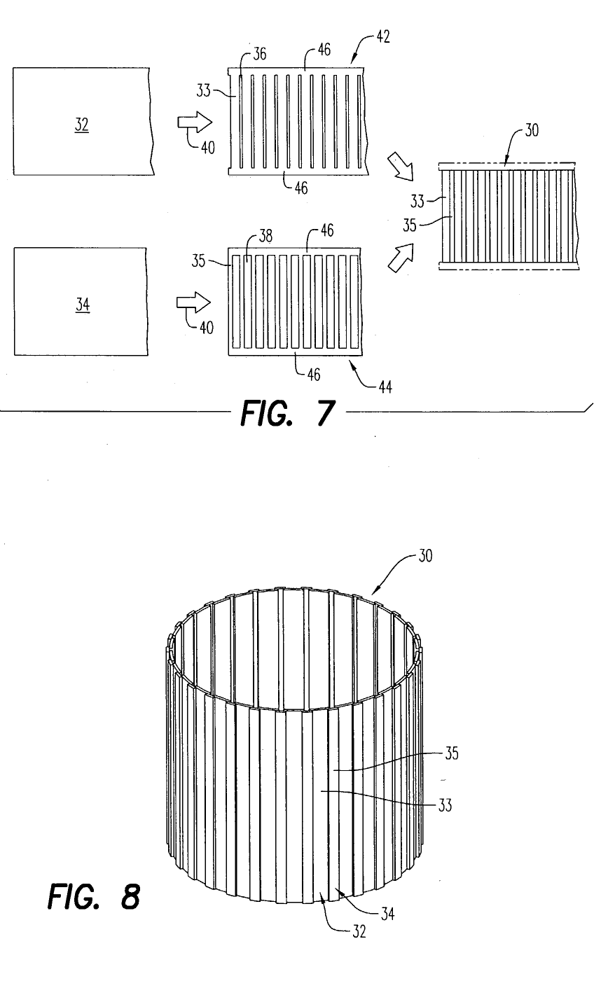

It has been found that replacing tooth tips 26 with a stator core liner 30 resolves the above described and other disadvantages. Referring now to FIGS. 5 and 6, an exemplary embodiment of stator core liner 30 contemplated for use with the present disclosure is illustrated.

Stator core liner 30 is a multi-layer element comprising a magnetically conductive layer 32 and an insulating layer 34. The conductive layer 32 comprises a plurality of spaced apart conducting strips 33. The insulating layer 34 comprises a plurality of spaced apart insulating strips 35.

Specifically, each conducting strip 33 is separated by a slit, open area, or channel 36 (hereinafter “slit”) and each insulating strip 35 is separated by a slit, or open area, or channel 38 (hereinafter “slit”). Thus, stator core liner 30 is ribbon-like, namely the liner alternates between overlapping conducting strips 33 on one side and insulating strips 35 on the other side.

The slits 38 are sized to have a depth such that the insulating strips 35 can be inserted into the openings 21 of the stator core 12 after the windings are inserted therein. The slits 36 are sized to have a depth such that the conducting strips 33 can rest upon the inner diameter of the stator core 12 and at least partially overlap opening 21. Thus, and through the insulating and conducting properties of the strips 33 and 35 and their position on the stator core 12, the stator core liner 30 replaces the tooth tips and the slot wedges discussed above. Namely, when the liner 30 is installed in stator 12, the liner reduces the slot openings 21 to a predetermined dimension equal to the width of the slits 36 of the conductive layer 32.

As a result of removing the tooth tips, slots 22 have an unrestricted opening or gap 21, which is at least as wide as the width of slot 22. Thus, slots 22 each now have an open “U” shaped configuration. Of course, other types of open configurations are contemplated with the present disclosure. Stator core liner 30 is inserted into bore 20 after stator windings 24 are placed into slots 22. Since slots 22 have unrestricted opening 21, stator windings 24 are more easily inserted therein, thus a more complete filling of the slots with the windings is achievable. For example in an exemplary embodiment, over 80% of each slot 22 is filled with windings 24. Thus, increasing the percentage of windings 24 in slots 22 is simplified by eliminating the tooth tips from stator core 12. Moreover, windings 24 are more easily inserted into slots, even if a larger cross-section of wire is used.

In an exemplary embodiment, stator core liner 30 has an overall thickness of about 0.75 mm to 1.25 mm. Here, conductive layer 32 has a thickness of about 0.5 mm to 1.0 mm, and insulation layer has a thickness of about 0.25 mm. Of course, stator core liners having a larger or smaller thickness is contemplated to be within the scope of the present disclosure.

Thus, conductive layer 32 having slits 36 replaces the tooth tips 26, while insulating layer 34 having slits 38 replaces slot wedges 28 and insulates windings 24 from the conductive layer. Accordingly, stator core liner 30 secures and insulates windings 24 in slots 22.

Conductive layer 32 is secured to stator core 12 by mechanical, adhesive or thermal means. In an exemplary embodiment shown in FIG. 6, conductive layer 32 includes an adhesive 40. Adhesive 40 is preferably a heat activated adhesive such that application of heat bonds strips 33 of conductive layer 32 of stator core liner 30 to stator core 12. Additionally, varnishing or potting of stator core 12 provides additional bonding of stator core liner 30 to the stator. Thus, stator core liner 30 provides the features of the tooth tips, provides insulation, and retains windings 24.

Liner 30 is described above by way of example only as being is inserted into bore 20 of stator 12. However, it is also contemplated for the liner 30 to be used with other types of electrical machines. For example, some electric machines have a wound field rotor that includes windings in slots defined in the rotor in a manner similar to the stator described above. In this embodiment, the liner can be disposed on the rotor such that the insulating strips rest in the slots and the conducting strips rest on the rotor to reduce the width of the rotor openings.

Alternately, some electric machines have an inside-out configuration, namely one where the rotor includes central bore 20 to receive stator 12. Thus in the inside-out configuration, slots 22 are disposed on the outer diameter of stator 12. In this embodiment, liner 30 is disposed on the outer diameter of stator 12 such that slits 36 are intermediate opening 21 of each slot 22, and such that slits 38 rest between each tooth.

Accordingly, it is considered in the scope of the present disclosure for liner 30 to be installed not only in bore 20 of stator 12, but also on other types of electric machines. Namely, it is considered in the scope of the present disclosure for liner 30 to be installed in electric machines having slots 22 filled with windings 24, where use of liner 30 replaces tooth tips 26 and/or slot wedge 28.

Referring now to FIG. 7, an exemplary embodiment of a process for making stator core liner 30 is illustrated. Here, magnetically conducting layer 32 is provided in a ribbon form 42 and insulating layer 34 is provided in a ribbon form 44. Preferably, ribbon 42 is electrical steel, iron, low carbon steel, or other ferromagnetic material. Ribbon 44 is preferably electrically insulating material such as, but not limited to, wedge paper (e.g., NOMEX), MYLAR, KAPTON, polymers, or the like.

Adhesive 40 is applied to one side of ribbon 42 and to one side of ribbon 44. Of course, and as other applications require adhesive 40 being placed on both sides of ribbon 42 is considered within the scope of the present disclosure.

Ribbon 42 is processed to have slits 36 on either side of strips 33, and ribbon 44 is processed to have slits 38 on either side of strips 35. Slits 36 have a width sufficient to properly located strips 33 to replace the tooth tips and reduce the eddy current losses that would otherwise result on the surface of rotor 14 due to air gap reluctance/flux variations. In addition, strips 33 are of a sufficient width to traverse between slots 22 while also having a remaining portion that hangs over the slot opening. Slits 38 have a width sufficient such that strip 35 is received within slots 22 of stator core 12. Strip 35 is also configured to be received within slot 22. A bridging portion 46 remains on both ribbons 42 and 44. Bridging portion 46 holds strips 33 and 35 of ribbons 42 and 44 in place until the ribbons are connected.

Next, ribbon 44 and ribbon 42 are connected to one another. Here, the ribbons 42 and 44 are connected such that slits 36 and 38 are staggered or stepped as illustrated in FIG. 6. Adhesive 40 on ribbon 44 secures the ribbons 42 and 44 to one another, while the adhesive on ribbon 42 remains exposed for connection to stator core 12.

After connecting ribbons 42 and 44 to one another, bridging portion 46 is removed. This creates a ribbon-like element having strips 33 of conductive layer 32 adhesively bonded to strips 35 of layer 34 where slits 36 in the conductive layer alternate with slits 38 in the insulation layer.

FIG. 8 illustrates an exemplary embodiment of stator core liner 30 for placement into bore 20. Here, stator core liner 30 is cut to a length to equal the circumference of bore 20 and is coiled to fit in bore 20. Next, the precut and coiled stator core liner 30 is inserted into bore 20, and then conductive layer 32 is connected to stator core 12 as described above.

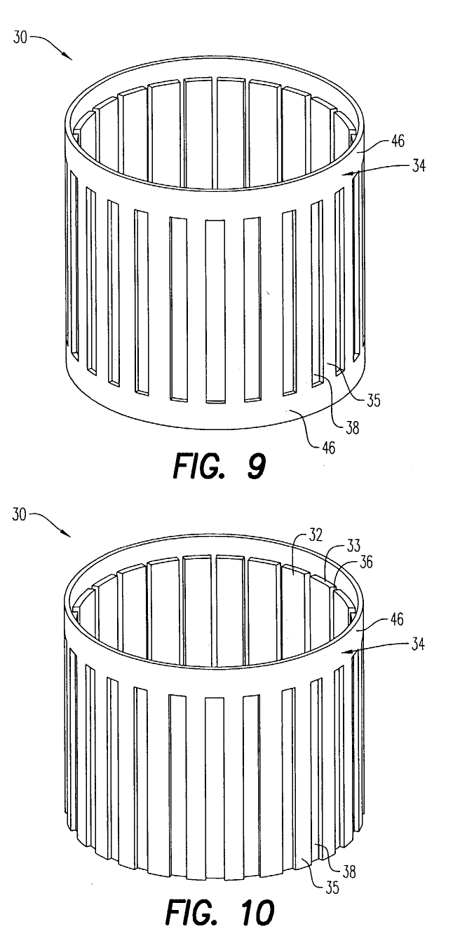

In an alternative embodiment shown in FIG. 9, bridging portion 46 is removed from ribbons 42, but not from ribbons 44. Thus, in this embodiment ribbon 44 remains a single continuous ribbon, having slits 38 disposed therein and ribbon 42 connects to stator core 12 through slits 38 of ribbon 44.

In another alternative embodiment illustrated in FIG. 10, bridging portion 46 is removed from ribbon 42, but from only one end of ribbon 44. Thus, in this embodiment ribbon 44 remains a single continuous ribbon, having slits 38 disposed therein and ribbon 42 connects to stator core 12 through slits 38 of ribbon 44.

Alternately, conducting strips 33 and insulating strips 35 can be manufactured as separate parts without bridging portions 46. Strips 35 are inserted into slots 22 to secure windings 24 and strips 33 are assembled to stator core 12 so that strips 33 are placed equally between adjacent stator slots 22 and slot openings 21 are located at the center of stator slots 22.

The conducting strips 33 can be manufactured as separate parts and the insulating strips 35 can be manufactured as a single ribbon 44 with bridging portions 46 at each end. Ribbon 34 is installed into stator core 12 and inserted into slots 22 to secure windings 24 and conducting strips 33 are 5 assembled to core 12 so that strips 33 are placed equally between adjacent slots 22 and slot openings 21 are located at the center of slots 22.

The conducting strips 33 can also be manufactured as separate parts and the insulating strips 35 can be manufactured as a single ribbon 44 with bridging portions 46 at one end. Ribbon 34 is installed into stator core 12 and inserted into slots 22 to secure windings 24 and conducting strips 33 are assembled to core 12 so that strips 33 are placed equally between adjacent slots 22 and slot openings 21 are located at the center of slots 22.

Referring now to FIG. 11, another alternative exemplary embodiment for stator core liner 30 is illustrated. In this embodiment, the conducting layer 32 is initially a continuous sleeve of conductive material 70. The insulating layer 34 is in the form of a sleeve of insulating material. The insulating layer 34 is disposed around the sleeve of conductive material 70. The insulating layer 34 includes the insulating spaces 38, the insulating strips 35, and the bridging portions 46. A trimming operation can be performed on the continuous sleeve 70. The trimming operation forms the conducting strips 33 and the conducting spaces 36 by removing only the material 72 (illustrated in phantom) from the continuous sleeve 70.

Of course and as other applications require, stator core liner 30 manufactured by other processes such that the liner provides both retaining and insulating functions while replacing tooth tips and slot wedges are considered within the scope of the present disclosure. For example, insulating layer 34 being sprayed, printed or the like on conductive layer or on stator core 12 having windings 24 inserted in slots 22 is considered within the scope of the present disclosure. Alternately, slits 36 being end machined into, or otherwise removed from, conductive layer 32 (e.g., ribbon 42) after insertion and connection to stator core 12 is considered within the scope of the present disclosure.

It should be noted that insulating layer 34 insulates electrically and magnetically conductive layer 32 from windings 24. In the event that windings 24 are secured in slots 22 with sufficient rigidity to so as to ensure that the winding does not come into contact with the conductive layer during use of motor 10, then no insulating layer 34 is required in liner 30. For example, it is considered within the scope of the present disclosure for windings 24 to be bonded in slots 22 by an epoxy or an adhesive. Here, windings 24 impregnated in a layer of adhesive are inserted into slots 22 to secure the windings in slots 22 with sufficient rigidity so as to ensure that the windings do not move. Thus, in this embodiment, insulation 23 in slots 22 is also eliminated, namely the adhesive on windings 24 takes the place of not only layer 34, but also of the slot insulation 23.

Of course, and as other applications require, other methods of inserting stator core liner 30 into stator core 12 are considered within the scope of the present disclosure. Accordingly, use of stator core liner 30 with stator core 12 (e.g., replacing tooth tips and retaining ring) adds increased manufacturing flexibility, decreases overall cost while increasing the performance of motor 10 by increasing the density of windings 24 in slots 22.

Conductive layer 32 of liner 30 is described above by way of example as being secured to stator core 12 by adhesive 40. Similarly, conductive layer 32 is described by way of example as being secured to insulating layer 34 by adhesive 40. Alternate exemplary embodiments of liner 30 are shown in FIGS. 11-16. Here, various methods other than adhesive 40 for connecting the conductive layer to the stator and/or to the insulating layer are shown. Here, elements performing similar or analogous functions are numbered in multiples of one hundred.

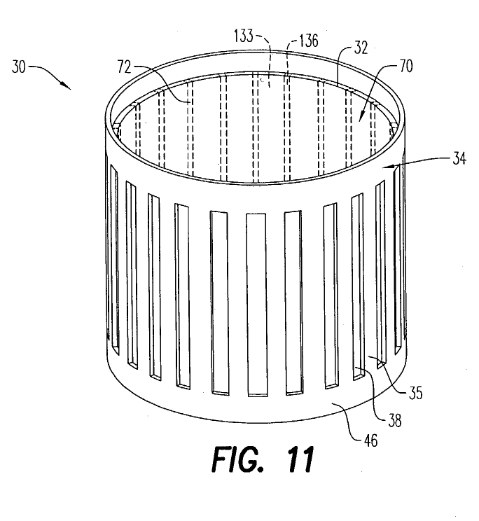

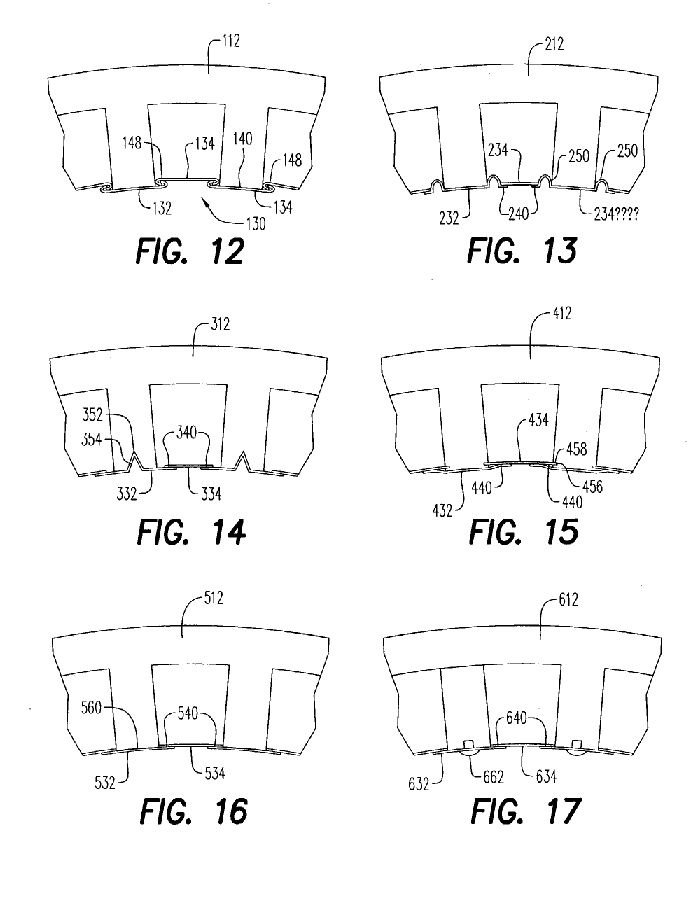

An alternative embodiment of stator 112 having liner 130 is illustrated in FIG. 12. Here, conductive layer 132 is secured to stator 112 by adhesive 140. Additionally, conductive layer 132 is secured to insulating layer 134 by way of interlocking clips 148.

Another alternative embodiment of a stator 212 having a liner 230 is illustrated in FIG. 13. Here, conductive layer 232 is secured to insulating layer 234 by way of adhesive 240. However, conductive layer 232 is secured to stator 212 by way of biasing clips 250.

Yet another alternative embodiment of a stator 312 having a liner (not shown) is illustrated in FIG. 14. Here, conductive layer 332 is secured to insulating layer 334 by way of adhesive 340. However, conductive layer 332 is secured to stator 312 by way of an interference fit between notches 352 in the stator and protrusions 354 on the conductive layer.

FIG. 15 illustrates another alternative exemplary embodiment of a stator 412 having a liner 430. Here, conductive layer 432 is secured to insulating layer 434 by way of adhesive 440. However, insulating layer 434 is used to connect conductive layer 432 to stator 412. Namely, insulating layer 434 includes fingers 456 that form a close fit with notches 458 in stator 412.

An alternative exemplary embodiment of a stator 512 having a liner 530 is illustrated in FIG. 16. Here, conductive layer 532 is secured to insulating layer 534 by way of adhesive 540. However, conductive layer 532 is secured to stator 512 by way of a weld, braze, or solder 560.

Yet another alternative exemplary embodiment of a stator 612 having liner 630 is illustrated in FIG. 17. Here, conductive layer 632 is secured to insulating layer 634 by way of adhesive 640. However, conductive layer 632 is secured to stator 612 by way of a screw 662.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A liner for a stator of an electric machine, comprising:
an insulating layer comprising a plurality of insulating strips; and
a magnetically conducting layer comprising a plurality of conducting strips, said insulating layer and said conducting layer being connected to form a ribbon-like element, said ribbon-like element having a length alternating between said conducting strips and said insulating strips in an overlapped manner, and said ribbon-like element being configured to be connected to the stator such that said insulating strips are positionable in winding slots of the stator, each of said winding slots having an opening comprising a uniform width with respect to said winding slot, said conducting strips being mateable with a surface of the stator across said opening.

2. The liner of claim 1, wherein a portion of a pair of adjacent conducting strips overlap a portion of said opening at opposites sides of said opening.

3. The liner of claim 1, wherein said conducting strips act as tooth tips.

4. The liner of claim 1, further comprising: means for connecting said ribbon-like element to said stator core.

5. The stator core liner of claim 4, wherein said means for connecting is selected from the group consisting of adhesive bonding, thermal bonding, and mechanical bonding.

6. The stator core liner of claim 5, wherein said adhesive bonding is a heat activated adhesive disposed on said conducting strips.

7. The stator core liner of claim 1, wherein said conducting layer is electrical steel and said insulating layer is slot liner paper.

8. The stator core liner of claim 7, wherein said conducting layer is connected to said insulating layer by an adhesive or by a mechanical connection.

9. A stator or rotor for an electric machine, comprising:
a stack of surface insulated ferromagnetic laminations, said stack including winding slots disposed circumferentially about said stack, each of said winding slots having an unrestricted opening.

10. The stator or rotor of claim 9, further comprising:
windings disposed in each of said winding slots; and
a liner being connected to said stack about said unrestricted openings to form tooth tips across said unrestricted openings.

11. The stator or rotor of claim 10, wherein said liner comprises:
a ribbon-like element, said ribbon having a length alternating between conducting strips and insulating strips in an overlapped manner, and said ribbon-like element being connected to said stack such that said insulating strips are positioned in said winding slots and such that said conducting strips mate with said stack to form tooth tips across said unrestricted opening.

12. The stator or rotor of claim 11, wherein said conducting strips are spaced apart from one another by a gap and are connected about said unrestricted openings such that said gap is intermediate said unrestricted openings.

13. The stator or rotor of claim 12, further comprising:
an adhesive securing said windings in said winding slots.

14. The stator or rotor of claim 13, wherein said liner comprises:
conducting strips being connected to said stack to form tooth tips across said unrestricted opening.

15. The stator or rotor of claim 14, wherein said conducting strips are spaced apart from one another by said gap.

16. The stator or rotor of claim 10, further comprising:
means for connecting said liner to said stack.

17. The stator or rotor of claim 16, wherein said means for connecting is selected from the group consisting of adhesive bonding, thermal bonding, and mechanical bonding.

18. An electric machine, comprising:
a stator core including a stack of surface insulated ferromagnetic laminations, said stack having an inner bore, said inner bore having stator winding slots disposed circumferentially therearound, each of said stator winding slots having an unrestricted opening;
stator windings disposed in each of said stator winding slots;
a stator core liner being connected to said inner bore about said unrestricted openings to form tooth tips at said unrestricted openings; and
a rotor being rotatably disposed in said inner bore.

19. The electric machine of claim 18, wherein said stator core liner is an element having a length alternating between overlapping conducting strips and insulating strips, and said element being connected to said stator core such that said insulating strips are positioned in said stator winding slots and such that said conducting strips are mated with said inner bore.

20. The electric machine of claim 19, wherein said conducting strips are spaced apart from one another by a gap and are connected about said unrestricted openings to form said tooth tips.

21. The electric machine of claim 18, wherein an adhesive secures said stator windings in said stator winding slots, and said stator core liner is an element having conducting strips connected to said inner bore such that said conducting strips form said tooth tips.

22. The electric machine of claim 18, wherein said stator core liner is connected to said inner bore by a means for connecting selected from the group consisting of adhesive bonding, thermal bonding, and mechanical bonding.

23. The stator or rotor of claim 10, wherein said stack of surface insulated ferromagnetic laminations is replaced by either a solid core or a powdered metal core each having winding slots disposed circumferentially about said core, each of said winding slots having an unrestricted opening.
